(19) United States
(12) Patent Application Publication
(10) Pub. No.: US 2004/0208852 A1
(43) Pub. Date: Oct. 21, 2004

(54) Method for colonizing a plant with an ectomycorrhizal fungus

(75) Inventors: Andrew P. Coughlan, Quebec (CA); Yves Piche, Cap-Rouge (CA)

Correspondence Address: OGILVY RENAULT, 1981 MCGILL COLLEGE AVENUE, SUITE 1600, MONTREAL, QC, H3A2Y3, CA

(73) Assignee: UNIVERSITE LAVAL, Quebec (CA)

(21) Appl. No.: 10/813,071

(22) Filed: Mar. 31, 2004

Related U.S. Application Data
(60) Provisional application No. 60/459,993, filed on Apr. 4, 2003.

(51) Int. Cl. A01N 63/00; A01N 63/04; A01N 65/00

(52) U.S. Cl. 424/93.5; 504/117

(57) ABSTRACT

The present invention relates to a method and a system for colonizing a plant with a mycorrhizal fungus that comprise placing at least one layer of a culture medium that comprises a fungal inoculum adjacently to at least one layer of a soil. The fungal inoculum is allowed to grow through the soil layer and the plant is inserted into the culture medium and soil layers to permit its contact with the fungus.

### BACKGROUND OF THE INVENTION

(a) Field of the Invention

The present invention relates to a method and a system for colonizing a plant in vitro with an ectomycorrhizal fungus. The present invention also relates to the use of the system of the present invention to colonize a plant with an ectomycorrhizal fungus.

(b) Description of Prior Art

Mycorrhiza are symbiotic associations in which fungi become integrated into the physical structure of the roots of a plant. Ectomycorrhiza (EM) and endomycorrhiza are the two basic types of mycorrhizal associations. Endomycorrhizal fungi invade the living cells of the root which become filled with mycelial clusters. In a widespread form of endomycorrhiza, the microscopic appearance of intracellular hyphal clusters leads to the name of vesicular-arbuscular (VA) mycorrhiza. By contrast, the EM fungal hyphae penetrate the intracellular spaces of the epidermis and of the cortical region of the root but do not invade the living cells. The morphology of the root is altered, forming a shorter, dichotomously branching cluster with a reduced meristematic region. The external pseudoparenchymatous sheath formed by EM fungi can constitute up to 40% of the dry weight of the combined root-fungus structure.

The number of plants capable of normal development in the absence of mycorrhizal formation is very limited. The majority of plants rather rely on such mycorrhizal association for their normal growth and development. For example, EM act as an extension of the colonized plant's roots, increasing the plant's absorbative surface by approximately 700%, allowing additional uptake of water and nutrients. The EM association reduces drought stress and the need for artificial fertilizer and pesticides since the plant derives several benefits from its association with EM fungi, including increased longevity of feeder roots, increased rates of nutrient absorption from soil, selective absorption of certain ions from soil, resistance to plant pathogens, increased tolerance to toxins and increased tolerance to extremes of a range of environmental parameters, such as temperature, drought and pH. In counterpart, EM fungi benefit from carbohydrates, amino acids and vitamins produced by the plant.

The benefits provided by the symbiotic association also find an important application in the in vitro production of plants. While in vitro plant propagation techniques allow rapid multiplication of clonal material of many species for horticultural, agricultural and research purposes, acclimation of the plants to ex vitro conditions remains a problem and many vitroplants are lost. An increasing number of studies show that plants colonized by symbiotic mycorrhizal fungi are advantaged, being more resistant to ex vitro acclimation. The available techniques for colonization of in vitro germinated seedlings or vitroplants are performed in or on gel-based media. Although these techniques allow colonization of the roots of plants, the gel-based media is difficult to remove from the roots and offers a suitable growth medium for detrimental bacteria and saprophytic fungi when plants are transferred to ex vitro conditions. Therefore, it can negatively affect plant survival during acclimation.

Following acclimation, plants are grown in soil based substrates. Plants colonized by EM fungi that produce edible fruit bodies, such as black truffle, chanterelles, ceps and pine mushrooms, are highly sought after for the establishment of plantations and there is an international trade in these plants. However, export regulations generally require the plants to be grown in a soil free substrate to reduce the risk of transferring plant pathogens, as there is a risk of transferring plant diseases outside their natural distribution range.

Therefore, it would be highly desirable to be provided with a method and a system to colonize in vitro a plant with an EM fungus that prevents the development of undesirable microorganisms throughout the acclimation of the plant to ex vitro conditions while fulfilling soil exportation requirements.

### SUMMARY OF INVENTION

One object of the present invention is to provide a method for colonizing a plant with an ectomycorrhizal fungus. The method of the present invention comprises inoculating a culture medium with the ectomycorrhizal fungus purported to colonize the plant, adjoining at least one layer of the culture medium to at least one layer of a soil to form a plant colonizing system, inserting at least one root of the plant into the plant colonizing system; and cultivating that plant in the colonizing system for a period of time sufficient to allow at least one root to contact the ectomycorrhizal fungus. The method of the present invention may also comprise allowing the ectomycorrhizal fungus to colonize said soil prior to inserting the plant into the colonizing system.

Another object of the present invention is to provide a system for colonizing a plant with an EM fungus that comprises at least one layer of a culture medium adjoining at least one layer of a soil, wherein said culture medium is inoculated with said EM fungus. It is also an object of the present invention to provide the use of the system of the present invention to colonize a plant with an EM fungus.

### BRIEF DESCRIPTION OF DRAWINGS

FIG. 1 is a cross-section view of a recipient filled with a layer of moistened vermiculite sandwiched between two inoculum gel plugs.

FIG. 2 is a front view of a vitroplant inoculated by the method according to the invention.

### DESCRIPTION OF PREFERRED EMBODIMENTS

The present invention provides a method and a system for colonizing a plant with an EM fungus. The method and the system of the present invention may be used to colonize a plant with any EM fungus, such as a fungus belonging to the genera Boletus, Rhizopogon, Tricholoma or Tuber. Tuber genus fungi are preferably used as inoculum and more preferably the species Tuber melanosporum, since it produces the black truffle, which is the most valuable EM fungal fruit body.

The culture medium of the present invention may be a liquid or a semi-liquid medium but a solid culture medium is preferred. Any skilled artisan would understand that any medium enabling the concomitant growth or propagation of a plant or of a plant tissue and of a fungus may be used for the purpose of the present invention and includes White's Medium (WM) and its derivatives. However, minimal (M) medium, as reported by Bécard and Fortin in 1988 is preferably used for the purpose of the present invention.

The culture medium of the present invention is preferably inoculated with a fungus prior to being used as a constituent of the plant colonizing system. The medium may be inoculated with a fungus by any proper method, but is preferably inoculated using a root-organ, and more preferably a root-organ from Cistus incanus, itself colonized by the ectomycorrhizal fungus. For example, a plug from a solid culture medium comprising a portion of a root-organ colonized by the ectomycorrhizal fungus may be removed from a colonized actively growing root-organ culture to further be adjoined to at least one layer of a soil to constitute the colonizing system of the present invention.

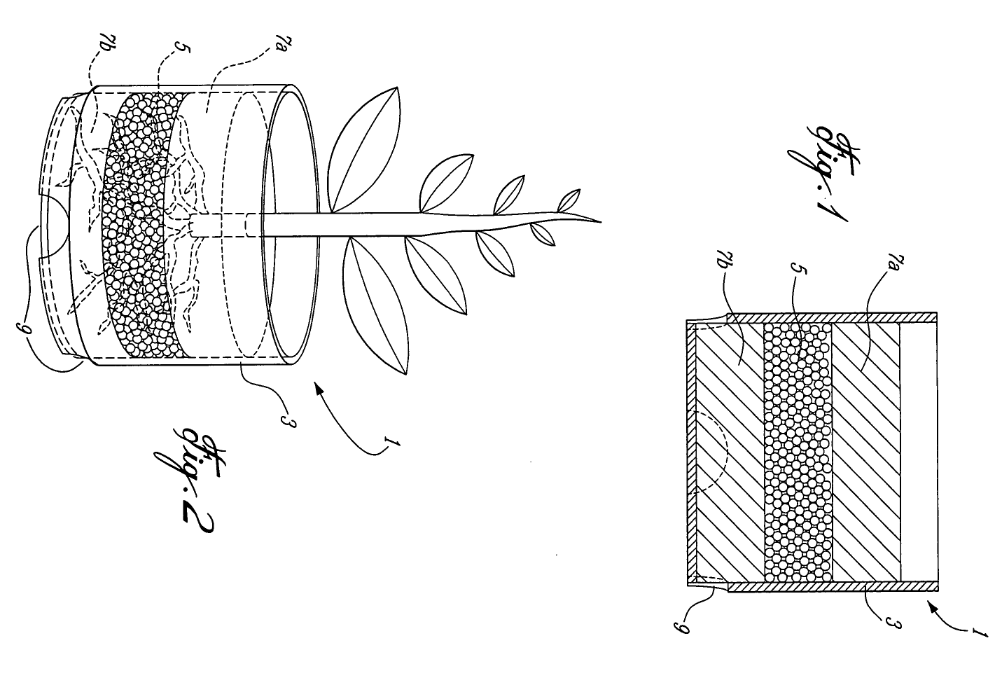

An embodiment of the present invention is illustrated in FIGS. 1 and 2. The plant colonizing system (1) comprises a recipient (3) in which is placed one layer of a soil (5), sandwiched between two layers of culture medium (7a and 7b), these layers of culture medium being inoculated with the ectomycorrhizal fungus. The recipient of the present invention is preferably an upside-down Kim-Kap™, modified to comprise apertures (9) at its closed end. However, any recipient that enables the arrangement of the system of the present invention can be used. A person skilled in the art will also understand that the system of the present invention may be constructed in the absence of a recipient, especially with a solid culture medium and a non friable soil, capable of standing on by itself. Although a layer of soil sandwiched between two layers of culture medium is preferred, a skilled artisan will understand that the plant colonizing system of the present invention may comprise only one layer of a soil adjoining only one layer of a culture medium or that multiple alternating layers of soil and culture medium may be used.

The soil of the present invention may be any soil that enables the growth of a plant such as peat moss, compost or gardening earth but is preferably sterile vermiculite and more preferably a moistened sterile vermiculite. Sterilization of vermiculite allows the removal of any microorganism from the soil and therefore, permits the exportation of such a soil since it fulfills the exportation requirements. The soil may be sterilized by any proper way that include gas sterilization, heat sterilization, autoclave and gamma (y) radiations. The method used for sterilizing the soil should however not leave any trace of foreign compound that could negatively affect the growth or the proliferation of the plant, the fungus or both the plant and the fungus.

The soil may be moistened using any liquid that has no negative effect on the growth or the proliferation of the plant, the fungus or both the plant and the fungus. However, the moistened sterile vermiculite is preferably obtained by adding a mix of Ca(OH)₂ and modified PDMmA medium to the sterile vermiculite.

The colonizing system of the present invention is preferably incubated prior to insertion of the seedling of the plant to be colonized by the EM fungus in conditions that allow the fungus to invade and colonize the layer of soil. Therefore, the EM fungus is substantially homogenously distributed in the colonizing system which maximizes the efficiency of the colonization of the plant grown in the system.

The present invention will be more readily understood by referring to the following examples which are given to illustrate the invention rather than to limit its scope.

### EXAMPLE I

### Preparation of Cistus Incanus Root-Organ Cultures

The plant from which a root-organ culture is obtained is preferably Cistus incanus, a shrubby plant known to form EM associations with fungi. Seeds of C. incanus were obtained from the Institut Botanique de l'Université Coimbra, Portugal (Universidade-Coimbra) and the Orto Botanico dell'Universita, Via P. A. Mattiolo n.4, 53100 Siena, Italy.

Briefly, axenic seedlings of C. incanus were obtained by germinating, in glass Petri dishes filled with damp sterilized sand, seeds that were surface sterilized with H₂O₂ (30 vols.) for 15 to 20 minutes and heat treated at 100° C. for 20 to 30 minutes.

Using a sterile syringe needle, seedlings were wounded on one of their leaves and were inoculated after 1 to 2 minutes with cells of A. rhizogenes sampled from a 48-hour-old culture. The A. rhizogenes isolate LBA 9402 used for the purpose of the present invention was supplied by Dr David Tepfer (Laboratoire de biologie de la rhizosphere, Institut National de la Recherche Agronomique (INRA), F-78026, CEDEX Versailles, France). Cultures of the LBA 9402 A. rhizogenes isolate were maintained on yeast-mannitol agar medium (pH 7) that comprises, for one liter of culture medium, 10 g mannitol, 0.4 g Yeast extract, 0.1 g NaCl, 0.5 g K₂HPO₄, 2.0 g MgSO₄.7H₂O, and 15 g Agar. Inoculated seedlings were incubated under ambient conditions for a 2 week period, after which transformed roots were obtained at the wound sites.

To remove A. rhizogenes from the transformed roots and to develop root-organ cultures, root tips (2-3 cm) were transferred to a modified White's (WM) medium amended with either rifampicin (50 mg/L) or a mix of cefotaxime 200 mg/L and carbenicillin 500 mg/L. The WM medium comprises, for one liter of culture medium, 731 mg MgSO₄.7H₂O, 453 mg Na₂SO₄10H₂O, 80 mg KNO₃, 65 mg KCl, 21.5 mg NaH₂PO₄.2H₂O, 288 mg Ca(NO₃)₂.4H₂O, 8 mg NaFeEDTA, 0.75 mg KI, 6 mg MnCl₂4H₂O, 2.65 mg ZnSO₄7H₂₀, 1.5 mg H₃BO₃, 0.13 mg CuSO₄.5H₂O, 0.0024 mg Na₂MoO₄.2H₂O, 3 mg C₂H₅NO₂ (glycine), 0.1 mg C₁₂H₁₈Cl₂N₄OS (thiamine hydrochloride), 0.1 mg C₈H₁₂ClNO₃ (pyridoxine hydrochloride), 0.5 mg C₆H₅NO₂ (nicotinic acid), 50 mg C₆H₁₂O₆ (myo-inositol), 30 g Sucrose and 3.5 g Gel-Gro.

The pH was adjusted to 6.5 (using KOH) before adding the solution to the gelling agent. Once a week, actively growing root tips were transferred to fresh WM medium with antibiotics to obtain bacteria-free root-organs after four or five successive transfers. The bacteria-free Cistus root-organ cultures were maintained on WM pH 6.5, in 150 mm Petri dishes and incubated in the dark at −25° C., and 2 cm-long apical tips were transferred to fresh media once every 14 days.

Five root-organ clones from C. incanus were obtained with the method described herein above, namely clones 1, 1B, 2, 3 and 4. Since clone #2 was shown to be the most vigorous, it was selected for subsequent experiments.

### EXAMPLE II

### Colonization of Root-Organs by an Ectomycorrhizal Fungus

The colonization of root-organs by a selected fungus was performed by transferring 2 cm-long root tip segments from an actively growing C. incanus root-organ culture (Clone #2) into a 150 mm Petri dish comprising fresh WM medium and by incubating it for seven days. The product of this incubation was then transferred into a recipient containing minimal (M) medium. Minimal medium comprises, for one liter: 731 mg MgSO₄.7H₂O, 80 mg KNO₃, 65 mg KCl, 4.8 mg KH₂PO₄, 288 mg Ca(NO₃)₂.4H₂O, 8 mg NaFeEDTA, 0.75 mg KI, 6 mg MnCl₂.4H₂O, 2.65 mg ZnSO₄.7H₂₀, 1.5 mg H₃BO₃, 0.13 mg CuSO₄.5H₂O, 0.0024 mg Na₂MoO₄.2H₂O, 3 mg C₂H₅NO₂ (glycine), 0.1 mg C₁₂H₁₈Cl₂N₄OS (thiamine hydrochloride), 0.1 mg C₈H₁₂ClNO₃ (pyridoxine hydrochloride), 0.5 mg C₆H₅NO₂ (Nicotinic acid), 50 mg C₆H₁₂O₆ (myo-inositol), 10 g Sucrose and 5.5 g Gel-Gro. The pH of the medium was adjusted with KOH to the optimal growth pH of the fungus species used therein and ranged from 5.5. to 6.5.

A gel plug adjoining the growing tip of a developing lateral root was removed and further replaced by an identical sized and shaped sample cut from a gel comprising an actively growing fungal colony. A wide range of identified and non-identified ectomycorrhizal fungi were tested, and more particularly T. melanosporum. Since the TMEL0199 strain was the most vigorous strain of T. melanosporum, it was elected for the purpose of the root-organ colonization. The root-organ was then enabled to grow through the fungus colony, becoming itself colonized by the ectomycorrhizal fungus.

Results

The EM formation occurred five days after root-hyphal contact between C. incanus clone #2 and T. melanosporum TMEL0199. Clones 1, 1B, 3 and 4 also formed mycorrhiza with the tested fungi, within two to three weeks. The formation of EM with all isolates of known mycorrhizal fungi tested was obtained and root-organ cultures were used to stimulate growth and for the general maintenance of all cultures of Tuber species.

### EXAMPLE III

### Preparation of a Test Tube Cover System

12 ml of sieved vermiculite (<3 mm) were used to fill a 20 mm-diameter Kim-Kap™ (1 Kim-Kap™·plant⁻¹) and sterilized by autoclave at 121° C. for 120 minutes.

A solution of modified PDMmA was prepared by adding 15 g Potato dextrose broth, 7 g Malt extract, 10 ml KNO₂ (101 g·l⁻¹), 10 ml Ca(NO₂)₂.4H₂O (164 g·l⁻¹), 10 ml NaH₂PO₄.H₂O (37.2 g·l⁻¹), 10 ml MgSO₄.7H₂O (73.8 g·l⁻¹), 30 ml Sequestrene 330 Fe (3.73 g l-1) and 4 ml Micro-element mix (MnSO₄.H₂O, 11.5 g·l⁻¹; NaCl, 2.9 g·l⁻¹; H₃BO₃, 0.93 g·l⁻¹; CuSO₄.5H₂O, 0.12 g·l⁻¹; ZnSO₄.7H₂O, 0.15 g·l⁻¹; Na₂MoO₄.2H₂O, 0.012 g·l⁻¹; CoCl₂.6H₂O, 0.012 g·l⁻¹) to 926 ml of water. The solution of modified PDMmA and a suspension (2 g·l⁻¹) of Ca(OH)₂ were sterilized by autoclave (121° C., 20 min).

Sterilized vermiculite was moistened using, for 1 liter of sterile vermiculite, a cold mix of 350 ml of modified PDMmA and 75 ml of Ca(OH)₂ suspension.

Other 20 mm-diameter Kim-Kaps™ were modified by piercing three 5 mm orifices at the junction of the base and of the circumference, at 0, 120 and 240 degrees (FIG. 1). Kim-Kaps™ (1 Kim-Kap™·plant⁻¹) were sterilized (121° C., 30 min) and further used to assemble a plant colonizing system.

To produce a plant colonizing system, two 15 mm plugs were cut from vigorously growing co-cultures of a C. incanus root-organ and a strain of an EM fungus, in this case T. melanosporum, for every colonizing system assembled in a Kim-Kap™. A first gel plug was disposed at the base of a modified Kim-Kap™. The modified Kim-Kap™ containing the first inoculum plug was filled with sterilized and moistened vermiculite. Briefly, a 30 cm forceps was used to stabilize the modified Kim-Kap™ while the moistened vermiculite was transferred from the first Kim-Kap™ to the modified Kim-Kap™ by using another set of forceps, by inverting the forceps-held vermiculite-filled Kim-Kap™ and knocking it gently against the Kim-Kap™ containing the inoculum plug. The sterile base of the non-modified Kim-Kap™ was used to compact the vermiculite over the gel plug. The plant colonizing system was then completed by topping the modified Kim-Kap™ with the second plug of inoculum. The plant colonizing system was then incubated for four weeks before inserting a vitroplant or shootlet, so as to enable the fungal inoculum to invade the vermiculite layer.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

We claim:

1. A method for colonizing a plant with an ectomycorrhizal fungus that comprises:
inoculating a culture medium with said ectomycorrhizal fungus;
adjoining at least one layer of said culture medium to at least one layer of a soil to form a plant colonizing system;
optionally, allowing said ectomycorrhizal fungus to colonize said soil;
inserting at least one root of said plant into said plant colonizing system; and
cultivating said plant in said colonizing system for a period of time sufficient to allow said at least one root to contact said ectomycorrhizal fungus.

2. The method of claim 1, wherein said ectomycorrhizal fungus is Tuber melanosporum.

3. The method of claim 1, wherein said culture medium is inoculated using a root-organ colonized by said ectomycorrhizal fungus.

4. The method of claim 3, wherein said root-organ is a Cistus incanus root-organ.

5. The method of claim 1, wherein said culture medium is a solid culture medium.

6. The method of claim 1, wherein said soil is sterile vermiculite.

7. The method of claim 6, wherein said sterile vermiculite is moistened sterile vermiculite.

8. The method of claim 7, wherein said moistened sterile vermiculite has been obtained by adding a mix of Ca(OH)₂ and modified PDMmA medium to said sterile vermiculite.

9. A system for colonizing a plant with an ectomycorrhizal fungus that comprises at least one layer of a culture medium adjoining at least one layer of a soil, wherein said culture medium is inoculated with said ectomycorrhizal fungus.

10. The system of claim 9, wherein said ectomycorrhizal fungus is Tuber melanosporum.

11. The system of claim 9, wherein said culture medium is inoculated using a root-organ colonized by said ectomycorrhizal fungus.

12. The system of claim 11, wherein said root-organ is a Cistus incanus root-organ.

13. The system of claim 9, wherein said culture medium is a solid culture medium.

14. The system of claim 9, wherein said soil is sterile vermiculite.

15. The system of claim 14, wherein said sterile vermiculite is moistened sterile vermiculite.

16. The system of claim 15, wherein said moistened sterile vermiculite has been obtained by adding a mix of Ca(OH)₂ and modified PDMmA medium to said sterile vermiculite.

17. Use of the system of claim 9 to colonize a plant with an ectomycorrhizal fungus.

18. The use of claim 17, wherein said ectomycorrhizal fungus is Tuber melanosporum.
